(19) United States
(12) Patent Application Publication
(10) Pub. No.: US 2004/0200899 A1
(43) Pub. Date: Oct. 14, 2004

(54) Automatic toll collection architecture and method combining short-range and long-range communication schemes

(76) Inventors: Bor-Shenn Jeng, Yang-Mei (TW); Chun-Yo Shy, Yang-Mei (TW); Shen-Lung Tung, Yang-Mei (TW); Wern-Yarng Shieh, Yang-Mei (TW); Hong-Kai Yen, Yang Mei (TW); Shau-Sheng Tung, Yang-Mei (TW); Chao-Hao Lee, Yang-Mei (TW); Po-Jen Wang, Yang-Mei (TW); Yn-Tarng Jong, Yang-Mei (TW); Po-Wen Lu, Yang-Mei (TW); Rui-Yi Bai, Yang-Mei (TW)

Correspondence Address: RABIN & BERDO, P.C., Suite 500, 1101 14th Street, Washington, DC, 20005, US

(21) Appl. No.: 10/408,231

(22) Filed: Apr. 8, 2003

(51) Int. Cl. G07B 15/02

(52) U.S. Cl. 235/384

(57) ABSTRACT

An automatic toll collection architecture and method combining short-range and long-range communication schemes comprising a vehicle communication unit, a lane communication unit, a law-enforcement unit and a billing unit; said law-enforcement unit obtaining a first time and a first photo of a license plate of said vehicle; said lane communication unit recording a first coordinate and a second time of a vehicle communication unit as a first data, using said vehicle communication unit to transmit said first data to said billing unit; said law-enforcement unit obtaining a third time and a second photo of said license plate of said vehicle; said lane communication unit recording a second coordinate and a fourth time of said vehicle communication unit as a second data, using said vehicle communication unit to transmit said second data to said billing unit; said billing unit obtaining a fee and finishing a charging transaction.

### BACKGROUND OF THE INVENTION

1. Field of the Invention

The present invention is related to an automatic toll collection architecture and method combining short-range and long-range communication schemes, and more particularly, to an automatic toll collection architecture combining short-range and long-range communication scheme, which requiring only a minimum investment to enable toll collection and to solve the precision problem due to inadequate capability of the global positioning system.

2. Description of the Prior Art

Nowadays toll stations in every country are still using manual toll collection schemes, which induces considerable administrative cost. Besides, when drivers drive through a toll station, they need to stop their car to pay the tolls, thereby increasing the driving-through time and oil-consumption of every vehicle, and causing traffic jam. There are few countries implementing toll collection system at car lanes using dedicated short range communication (DSRC) to process transactions, or using global positioning system (GPS) with general packet radio service (GPRS) to implement electronic toll collection system to automate toll collection process. However, when using DSRC to implement bi-directional communication, it is difficult to transmit large amount of data in a small communication area; while using GPRS to transmit data allows more time to transmit large amount of data, it still presents precision problem of positioning.

Accordingly, the above-mentioned electronic toll collection architecture and method presents several shortcomings to be overcome.

In view of the above-described deficiency of prior-art automatic toll collection architecture and method using short-range or long-range communication schemes, after years of constant effort in research, the inventor of this invention has consequently developed and proposed an automatic toll collection architecture and method combining short-range and long-range communication schemes.

### SUMMARY OF THE INVENTION

The object of the present invention is to provide an automatic toll collection architecture and method combining short-range and long-range communication schemes, which requiring only a minimum investment to enable automatic toll collection.

It is another object of the present invention to provide an automatic toll collection architecture and method combining short-range and long-range communication schemes to solve the precision problem due to inadequate capability of the global positioning system.

The present invention discloses an automatic toll collection architecture and method combining short-range and long-range communication schemes, comprising:

a vehicle communication unit installed on the vehicle, comprising a short-range communication module and a long-range communication module;

a lane communication unit comprising a short-range communication post;

a law-enforcement unit comprising a camera and a sensor device; and

a billing unit coupled to the long-range communication module of the vehicle communication unit via a long-range communication device in a network;

The above-mentioned short-range communication module of the vehicle communication unit uses microwave for communicating with the lane communication unit in a short range; the long-range communication module of the vehicle communication unit using a vehicle communication device to communicate with the long-range communication device far away. The long-range communication device is coupled to the billing unit via the network, and the law-enforcement unit using the camera and the sensor device to automatically obtain and transfer a photo of the license plate of the vehicle to the billing unit via the network.

### BRIEF DESCRIPTION OF THE DRAWINGS

The drawings disclose an illustrative embodiment of the present invention which serves to exemplify the various advantages and objects hereof, and are as follows:

FIG. 1 shows an automatic toll collection architecture combining short-range and long-range communication schemes disclosed in the present invention;

FIG. 2 shows the flowchart of the automatic toll collection architecture and method combining short-range and long-range communication schemes.

### DETAILED DESCRIPTION OF THE PREFERRED EMBODIMENT

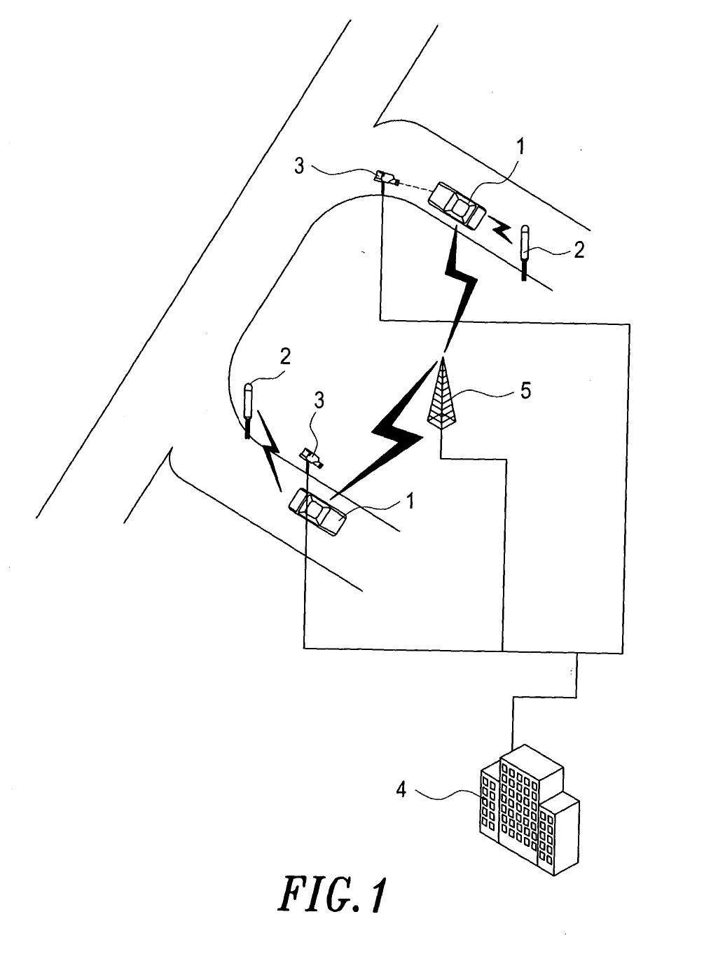

Please refer to FIG. 1, the present invention providing an automatic toll collection architecture and method combining short-range and long-range communication schemes, comprising:

a vehicle communication unit 1 installed on a vehicle, comprising short-range and long-range communication modules;

a lane communication unit 2 installed at a location suited for toll collection, including toll station, ramp entrance, ramp exit and other suitable places for toll collection, and the lane communication unit 2 comprising a short-range communication post;

a law-enforcement unit 3 comprising a camera and a sensor device, the law-enforcement unit 3 being installed at toll station, ramp entrance, ramp exit or other suitable places for toll collection; and

a billing unit 4 coupled to the long-range communication module of the vehicle communication unit 1 via a long-range communication device 5 in a network.

The short-range communication module of the vehicle communication unit 1 uses microwave as transmission medium for communicating with the lane communication unit 2 in a short range, and the lane communication unit 2 uses unidirectional broadcast scheme to communicate with the short-range communication module. The long-range communication module of the vehicle communication unit 1 uses a vehicle communication device to communicate with a long-range communication device 5 far away, and the long-range communication device 5 is coupled to the billing unit 4 via the network. The law-enforcement unit 3 using the camera and the sensor device to automatically obtain and transfer a photo of the license plate of the vehicle to the billing unit 4 via the network.

As mentioned above, the lane communication unit 2 uses unidirectional broadcast scheme, thus eliminating the need for additional communication network. The long-range communication module of the vehicle communication unit 1 communicates with the existed long-range communication device 5 (such as base station) far away, so only a minimum investment is required for implementing the automatic toll collection precisely. Furthermore, the lane communication unit 2 can be used as a complement to the global positioning system to enhance the precision of positioning, and the lane communication unit 2 is able to work with the law-enforcement unit 3 to identify vehicles violating regulations by comparing time data submitted by the two units respectively, thus eliminating the need of registration when purchasing the vehicle communication unit 1. Besides, the short-range communication module can also use infrared or other wireless transmission schemes to communicate with the lane communication unit 2 in a short distance. In addition, the long-range communication module of the vehicle communication unit 1 uses a mobile communication system to communicate with the long-range communication device 5 far away, the mobile communication system comprising mobile phone interfaces such as GSM and GPRS. The automatic toll collection architecture and method combining short-range and long-range communication scheme disclosed in the present invention is applicable to cases such as charged at main highway, charged at ramp, toll-free lanes, charged at separated lanes, charged by respective areas, charged by mileage, etc.

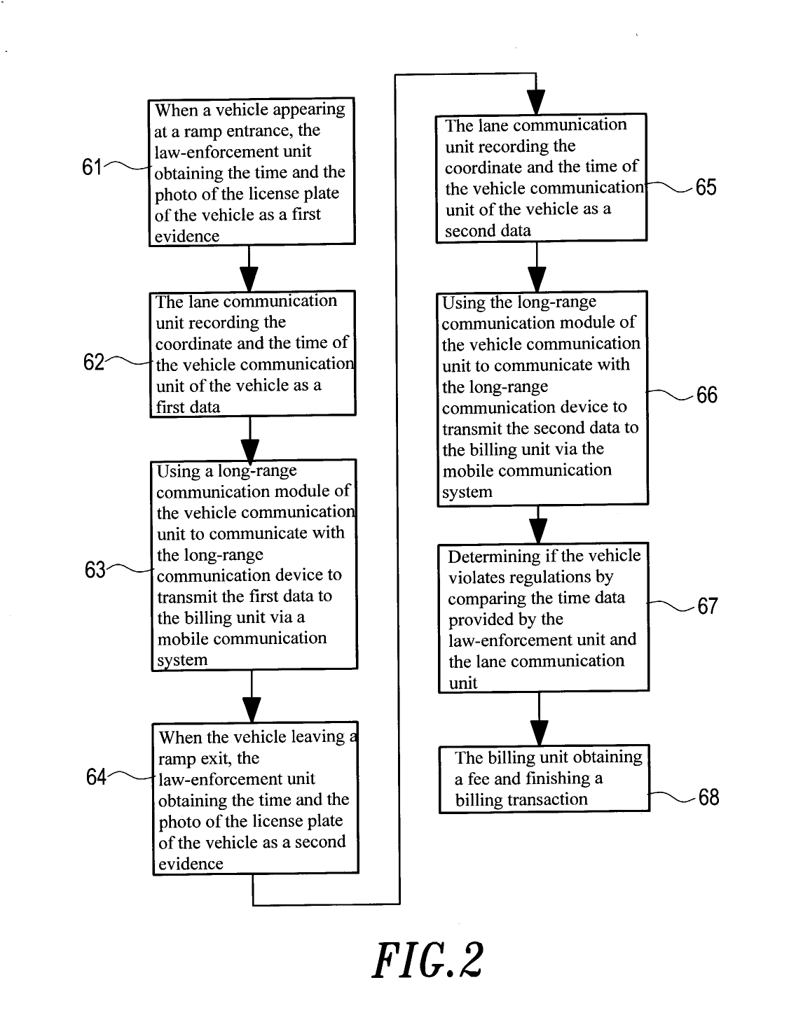

Please refer to FIG. 2 showing the flowchart of the automatic toll collection architecture and method combining short-range and long-range communication schemes in the present invention, comprising the following steps:

Step 1: When a vehicle appearing at a ramp entrance, the law-enforcement unit 3 obtaining the time and the photo of the license plate of the vehicle as a first evidence (61);

Step 2: The lane communication unit 2 recording the coordinate and the time of the vehicle communication unit 1 of the vehicle as a first data (62);

Step 3: Using a long-range communication module of the vehicle communication unit 1 to communicate with the long-range communication device 5 to transmit the first data to the billing unit 4 via a mobile communication system (63);

Step 4: When the vehicle leaving a ramp exit, the law-enforcement unit 3 obtaining the time and the photo of the license plate of the vehicle as a second evidence (64);

Step 5: The lane communication unit 2 recording the coordinate and the time of the vehicle communication unit 1 of the vehicle as a second data (65);

Step 6: Using the long-range communication module of the vehicle communication unit 1 to communicate with the long-range communication device 5 to transmit the second data to the billing unit 4 via the mobile communication system (66);

Step 7: Determining if the vehicle violates regulations by comparing the time data provided by the law-enforcement unit 3 and the lane communication unit 2 (67);

Step 8: The billing unit 4 obtaining a fee and finishing a billing transaction (68).

As described above, the billing unit 4 using the data transmitted by the lane communication unit 2 at ramp entrance/exit as the starting/current mileage to calculate the amount of toll, then it proceeds to charge the driver. The billing unit 4 may finish the billing transaction by charging the fee to driver's credit card, bank account or e-wallet IC card, etc.

Additionally, the billing unit 4 can obtain the billing data transmitted by the vehicle communication unit 1 via the network, then compares the billing data with the first and second evidence submitted by the law-enforcement unit 3 to determine if the vehicle has paid in accordance with the regulations, if not, then issues a payment notice or presses a charge.

The automatic toll collection architecture and method combining short-range and long-range communication schemes disclosed in the present invention, compared to prior art, are advantageous in:

1. The present invention utilizes the existed long-range communication device 5 (such as base station), so only a minimum investment is required for implementing the automatic toll collection precisely.

2. The lane communication unit 2 can be used as a complement to the global positioning system to enhance the precision of positioning

3. The lane communication unit is able to work with the law-enforcement unit to identify vehicles violating regulations by comparing time data submitted by the two units respectively, thereby protecting car owner's privacy by eliminating the need of registration when purchasing the vehicle communication unit.

4. The lane communication unit uses unidirectional broadcast scheme to communicate with the vehicle communication unit without the need to build additional network.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An automatic toll collection system combining short-range and long-range communication schemes, comprising:
a vehicle communication unit, said vehicle communication unit being installed on a vehicle, comprising a short-range communication module and a long-range communication module;
a lane communication unit, said lane communication unit being installed at a location suited for toll collection and comprising a short-range communication post;
a law-enforcement unit, said law-enforcement unit comprising a camera and a sensor device; and
a billing unit, said billing unit being coupled to said long-range communication module of said vehicle communication unit via a long-range communication device in a network;
said short-range communication module of said vehicle communication unit using microwave for communicating with said lane communication unit in a short range, said long-range communication module of said vehicle communication unit using a vehicle communication device to communicate with said long-range communication device far away, said long-range communication device being coupled to said billing unit via said network, said law-enforcement unit using said camera and said sensor device to automatically obtain and transfer a photo of a license plate of said vehicle to said billing unit via said network.

2. The system as recited in claim 1, wherein said short-range communication module uses wireless transmission schemes such as infrared for communicating with said lane communication unit.

3. The system as recited in claim 1, wherein said location suited for toll collection includes toll station, ramp entrance, ramp exit and other suitable places for toll collection.

4. The system as recited in claim 1, wherein said law-enforcement unit is installed at places such as toll station, ramp entrance, ramp exit and other suitable places for toll collection.

5. The system as recited in claim 1, wherein said lane communication unit uses unidirectional broadcast scheme to communicate with said short-range communication module in a short range.

6. The system as recited in claim 1, wherein said long-range communication module of said vehicle communication unit uses a mobile communication system to communicate with said long-range communication device far away, said mobile communication system comprising one of the following mobile phone interfaces, including GSM and GPRS.

7. An automatic toll collection method combining short-range and long-range communication schemes, comprising the following steps:
Step 1: A law-enforcement unit obtaining a first time and a first photo of a license plate of said vehicle as a first evidence when a vehicle appearing at a ramp entrance;
Step 2: A lane communication unit recording a first coordinate and a second time of a vehicle communication unit of said vehicle as a first data;
Step 3: Using a long-range communication module of said vehicle communication unit to communicate with a long-range communication device to transmit said first data to a billing unit via a mobile communication system;
Step 4: Said law-enforcement unit obtaining a third time and a second photo of said license plate of said vehicle as a second evidence when said vehicle leaving a ramp exit;
Step 5: Said lane communication unit recording a second coordinate and a fourth time of said vehicle communication unit of said vehicle as a second data;
Step 6: Using said long-range communication module of said vehicle communication unit to communicate with said long-range communication device to transmit said second data to said billing unit via said mobile communication system;
Step 7: Determining if said vehicle violates regulations by comparing said first time and said second time provided by said law-enforcement unit with said third time and said fourth time provided by said lane communication unit; and
Step 8: Said billing unit obtaining a fee and finishing a billing transaction.

8. The method of claim 7, wherein said billing unit obtaining said first and second data transmitted by said vehicle communication unit via a network, comparing said first data and second data with said first and second evidence submitted by said law-enforcement unit to determine if said vehicle has paid according to regulations, if not, then issuing a payment notice or pressing a charge.
